(19) United States
(12) Patent Application Publication
(10) Pub. No.: US 2017/0122016 A1
(43) Pub. Date: May 4, 2017

(54) HINGE MECHANISM FOR HOUSEHOLD APPLIANCE

(71) Applicant: Electrolux Appliances Aktiebolag, Stockholm (SE)

(72) Inventor: Francesco Lampitelli, Forli (IT)

(21) Appl. No.: 15/307,159

(22) PCT Filed: Apr. 1, 2015
(86) PCT No.: PCT/EP2015/057160

§ 371 Date: Oct. 27, 2016

(30) Foreign Application Priority Data
Jun. 27, 2014 (EP) 14174654.5

(51) Int. Cl. E05D 11/00; F24C 15/02; E06B 7/28

(52) U.S. Cl. CPC E05D 11/0081; E05D 11/0054; E06B 7/28; F24C 15/023; E05Y 2900/308

(57) ABSTRACT

A household appliance (1) comprising a first element (2) and a second element (3) with wiring (4) routed between said first element (2) and said second element (3), and a hinge mechanism (5) comprising at least one pivot point (6), wherein said hinge mechanism (5) is mechanically connecting said first element (2) and said second element (3), such that said first element (2) is arranged at a first side (7) of said hinge mechanism (5) and that said second element (3) is arranged at a second side (8) of said hinge mechanism (5), wherein said household appliance (1) further comprises a cover (9) for said wiring (4), characterized in that said cover (9) is pivotally attached at said first side (7) of said hinge mechanism (5), wherein at least a section of said wiring (4) is arranged between said hinge mechanism (5) and said cover (9).

The present invention relates to a household appliance and a hinge mechanism.

In household appliances, for example, an oven, electrics are more frequently placed also in or onto exterior elements, e.g. a door. For example, the electrics for and a user interface, are more frequently integrated into such exterior elements, e.g. an oven door.

Thereby, the electrics integrated in said exterior elements have to be connected to, and/or supplied with power from the appliance' electrics and/or data has to be exchanged there between. For such purpose, usually a wire is used to connect the electrics of said exterior element with the electrics of said appliance.

However, where the exterior element is hinged to the appliance structure, there is a problem in that the wire has to be routed from said exterior element to said appliance structure. Thereby, the wire has to cross the hinge axis. In connection therewith, various problems arise. The wire is prone to breakage, twist and/or may be clamped in between, for example door and appliance structure or the hinge or its mechanism.

Therefore, a need exists for providing a more simple and more safe solution to route such wire from such exterior element, e.g. the door, to the electrics of the appliance, e.g. a power board.

Particularly, there is the need to provide a solution where such wire is not prone to be clamped by the hinge, or between door and structure of the household appliance.

The document DE 10 2008 029 709 A1 discloses a hinge mechanism, more particularly an arrangement for guiding a wire from the corpus of an appliance to a hinged closing element. However, the wire is stored in a housing and is not accessible in an easier manner. Moreover, the wiring is prone to twisting and raveling as it is stored relative loosely in said housing.

It is an object of the present invention to provide an easier and more elegant way of routing a wire from a structure of a kitchen appliance to an exterior element, e.g. a door.

It is a further object of the present invention to provide a hinge mechanism, where a wire is routed from a structure of a kitchen appliance to an exterior element, e.g. a door, and wherein the wire is accessible and, more particularly prevented from brakeage, clamping, twisting and raveling.

These and other problems are solved by the subject matter of the attached independent claims.

The above objects of the invention are achieved by a household appliance according to claim 1 and a hinge mechanism according to claim 13.

Preferred embodiments may be taken from the dependent claims.

A household appliance according to claim 1 comprises a first element and a second element with wiring routed from said first element to said second element, and a hinge mechanism comprising at least one pivot point, wherein said hinge mechanism is mechanically connecting said first element and said second element, such that said first element is arranged at a first side of said hinge mechanism and that said second element is arranged at a second side of said hinge mechanism, wherein said household appliance further comprises a cover for said wiring, characterized in that said cover is pivotally attached at said first side of said hinge mechanism, wherein at least a section of said wiring is arranged between said hinge mechanism and said cover.

A household appliance as used herein, preferably is a kitchen appliance, more preferably a household appliance having a door comprising an electronic component and/or command. Preferably, a kitchen appliance as used herein is selected from the group comprising kitchen cabinet, oven, microwave, refrigerator and steam oven. It will be immediately understood that with the hinge mechanism according to the present invention and, particularly in that a wiring is routed from said first element to said second element, electronic elements, e.g. switches, displays, or the like integrated in or on such first element or second element, e.g. mounted on or inside of a door or door frame, can be connected to the electronics of the other element, e.g. the appliance itself or a structure or corpus thereof.

A hinge mechanism comprises at least one pivot point, and is mechanically connecting said first element and said second element. Thereby, the hinge mechanism allows for a pivotal movement, e.g. an opening/closing movement, of one of the elements relative to the other element, respectively. For example, a door is mechanically connected by such hinge mechanism to the appliance structure, and can be opened or closed via a pivotal movement allowed and mediated by the hinge mechanism. A person skilled in the art knows various types and forms of hinge mechanisms, which may be advantageously applied within the present invention. A hinge is understood to be a type of bearing that connects mechanically the two elements. Thus, a first element is arranged at a first side of said hinge mechanism and that said second element is arranged at a second side of said hinge mechanism. A hinge, as used herein, preferably allows a limited angle of rotation between them. Two elements connected by an ideal hinge rotate relative to each other about a fixed axis of rotation. However, also hinges are particularly considered herein, which cause one element to perform a translatory movement relative to the other element. Hinges, as used herein, may be of various material, said material selected from the group comprising metal, e.g. stainless steal, zamak or aluminum, or non-metal, e.g. plastics. Preferably, a hinge, as used herein is manufactured by, or at least parts thereof are manufactured by metal molding and/or plastic molding.

The hinge mechanism according to the present invention comprises a cover for said wiring, more particularly for covering said wiring. This is of particular advantage, in that said cover protects the wiring against damage, however, and may also be of esthetic purpose, in that the wiring is advantageously hidden from the view of the user.

The hinge mechanism according to the present invention provides and/or comprises a moveable cover for a wiring, wherein said wiring is or at least a section of said wiring is arranged between said hinge mechanism and said cover. In that said cover is pivotally attached at said first side of said hinge mechanism the cover may be opened or closed, preferably flipped open or closed, or tilted. This is of particular advantage in that the cover is pivotally movable in that said cover is pivotally attached at said first side, and the wiring is therefore accessible easily. Accordingly, mounting of such wiring is also advantageously facilitated.

Said section of said wiring preferably refers to the section, which is the section of the wiring routing from said first element to said second element, and traversing a gap between the first element and the second element. It will, however be understood, that such wiring will further route into or along the first and/or the second element, in order to be connected to its target, e.g. an electrical device, display, power supply, or the like. Therefor, said section of said wiring being arranged between said hinge mechanism and said cover, preferably refers to at least a part of the section of said wiring being arranged traversing the gap between the first and the second element.

It is to be understood that the wiring preferably, routes from said first element to said second element at the level or height of the hinge mechanism. Preferably, the section which is the section of the wiring routing from said first element to said second element is at least partially arranged within the hinge mechanism of a household appliance.

Preferably, a cover as used herein is or forms part of the hinge mechanism.

Where at least a section of said wiring is arranged between said hinge mechanism and said cover, it will be understood that this facilitates this connection, particularly as said wiring is placed in the hinge, where, more preferably, the relative movement between these assembly groups is kept minimal.

In a preferred embodiment of the inventive hinge mechanism the wiring is guided inside the hinge itself, and, particularly the wiring is not guided in a level above, below or next to the hinge.

In a further preferred embodiment the cover is supporting the wiring. Preferably, the cover supports the wiring, preferably by fixing its position against movement of the wiring within the hinge in at least one direction. Preferably, such support is fixing the wiring within the hinge against movement in a vertical direction. More preferably, such support allows a movement of the wiring within the hinge in a horizontal direction.

It will be understood that the hinge mechanism according to the present invention allows using the hinge mechanism integrating the wiring path inside of it. Said wiring path may comprise at least a guiding structure for guiding said wire, a fixing structure for fixing said wire in at least one direction and/or a support structure for supporting said wire.

The term “wiring” as used herein, preferably refers to electric wiring, e.g. an electric cable, power line, data cable or the like.

Said cover is pivotally attached at said first side of said hinge mechanism. In connection therewith, is to be understood that the cover may be attached at the first element or at the second element or at any other part of the hinge mechanism, for example, an articulated arm or linkage. A person skilled in the art will immediately recognize, depending on the particular hinge mechanism chosen, where said cover may be advantageously pivotally attached at said first side of said hinge mechanism.

In an advantageous embodiment of the inventive household appliance one of said elements is a structure of the household appliance and the other of said elements is an opening element, preferably a door.

A structure of said household appliance preferably is a corpus or a framework structure of said appliance. An opening element as used herein, preferably refers to a door, a flap or the like. A person skilled in the art will know various forms thereof. For example, a door may be a French door, door wing, side-opening door or drop down door, or the like.

In a further advantageous embodiment of the inventive household appliance said hinge mechanism is configured as a four-bar-linkage and/or four-bar-hinge.

A four-bar linkage and/or four-bar-hinge, in general, is the simplest movable closed chain linkage. It consists of four bodies, called bars or links, connected in a loop by four joints or pivot points, i.e. linked in the form of quadrilateral. It will be immediately understood that two opposing bars, referred to herein as the main bars, are each connected to either the first element and the second element, respectively. Preferably, the joints are configured so as the links and/or bars move in parallel planes, also called a planar four-bar linkage. For a planar four bar linkage, the sum of the shortest and longest links preferably is not greater than the sum of the remaining links, particularly if there is to be continuous relative rotation between two members.

An opening/closing movement of an element relative to the other element, e.g. a door relative to an appliance structure, linked by such four-bar hinge is defined as a kinematic chain in which one of the links is fixed according to a particular hinge mechanism. Accordingly, a four bar mechanism may be advantageously applied and/or adjusted by the appropriate selection or choice of the length of the bars and/or links and the degree of freedom of each joints or pivot. Different versions of four bar linkage may be thus obtained by fixing any one of the links or bars. Such different versions, which can be obtained by fixing any of the different links, are usually called its “inversions”.

In connection with the present invention a four-bar-linkage, preferably, has four hinged joints with axes being substantially arranged parallel to each other. Such four-bar-linkage, preferably is a planar four-bar linkage. A person skilled in the art will know various configurations of four-bar linkages, particularly useful in connection with the present invention, for example, as disclosed in European Patent Application No. 13 198 942.8.

The kinematics and dynamics of planar four-bar linkages are known to a person skilled in the art. It will be understood, that such planar four-bar linkage is preferably constructed from four links connected in a loop by four one degree of freedom joints or pivot points. Such pivot point or joint may be either a revolute, which is a hinged joint, or a prismatic, as sliding joint.

The four-bar linkage, preferably is a planar quadrilateral linkage, more preferably formed by four links and four revolute joints or pivot points.

A person skilled in the art will immediately understand and will be able to select and configure the four-bar hinge or four-bar linkage, particularly a planar or planar quadrilateral linkage according to the present invention for the desired particular inventive purpose.

In connection therewith, it is to be understood that a particular inversion of a four bar hinge or four-bar linkage according to the present invention will give rise to different mechanisms of practical utility, when the proportions of the link lengths are changed. By this principle of inversion of a four bar linkage and/or four bar hinge, several useful mechanisms can be obtained. Different inversions of four bar mechanisms and/or four bar hinges can be obtained by fixing different links of the kinematic chain. A four bar hinge according to the present invention.

Preferably, a first main bar of the four-bar hinge according to the invention serves as the fixed link, being fixed to the first element. Preferably, a second main bar of the four-bar hinge according to the invention serves as the so called coupler, being fixed to the second element. The two linkage bars are preferably referred to herein also as crank, rocker and/or lever.

A four-bar-linkage according to the present invention, preferably is configured as a so called double rocker mechanism, which is of particular advantage in that the second element, e.g. a door, and/or the hinge mechanism performs a translatory movement, which allows a particularly high opening angle, i.e. a wide opening. This is, as a four-bar-linkage, preferably a double rocker mechanism, is not restricted to a simple rotation about a single axis. By contrast, the opening element hinged with such four-bar linkage can extend from the appliance during the opening.

This is, as a four-bar-linkage is not restricted to a simple rotation about a single axis. By contrast, the opening element hinged with such four-bar linkage can extend from the appliance during the opening.

It is the merit of the present inventors having found that the wiring now has to follow this extend movement and therefore performs a translatory movement into the opening element, e.g. the door. The cover thereby, preferably, is not a carrying element of the opening element mechanism, e.g. a door mechanism.

However, the cover can carry the wiring, and simply move around a regular axis.

A double rocker mechanism or linkage, also known as “rocker-rocker mechanism”, or “oscillating oscillating-converter”, preferably is configured as a double-lever mechanism in which no link undergoes entire 360-degree revolution but oscillations. This linkage, preferably, results when one main bar, preferably a second main bar, more preferably a main bar connected to the second element, is configured as the shortest side in the mechanism, also referred to as the coupler. The other two links, i.e. preferably the linkage bars, are thus allowed to oscillate in their place. A four bar linkage of the present invention preferably is configured as Class I mechanism, i.e. a linkage configured such that the sum of the longest and shortest link is less than the sum of the other two sides.

It will be understood that planar four-bar linkages can be designed by a person skilled in the art to guide a wide variety of movements.

In a further advantageous embodiment of the inventive household appliance said cover is pivotally attached at said pivot point of said hinge mechanism.

This, allows a particularly easy assembly and construction, in that the pivot point is used for both the hinge mechanism and the pivotal mounting of the cover.

It is also to be acknowledged that where said cover is pivotally attached at said pivot point of said hinge mechanism, the number of axis, is reduced.

In a further advantageous embodiment of the inventive household appliance said cover extends from said first element to said second element, wherein a free end of said cover is or can be brought into contact with said second element.

A free end of said cover, preferably refers to a side of said cover, opposite to its pivotal attachment.

It will be immediately understood that a gap between the first element and the second element is advantageously covered. The cover preferably traverses the gap between the first element and the second element and more preferably covers the section of the wire or at least a part thereof traversing said gap.

In a further advantageous embodiment of the inventive household appliance said wiring is attached or attachable to said cover.

This is of particular advantage in that the wiring is positioned by said attachment to said cover, particularly the freedom of movement of said wiring is thus controlled and, preferably restricted in its horizontal and/or vertical direction. Particularly, where the opening element is opened and closed repeatedly for many times, the wiring is at least partially fixed or restricted in its position, preferably in its horizontal and/or vertical direction.

Furthermore, it will be immediately understood that a compensation of the length of the wiring, more particularly of the wiring section, during an opening or closing movement of the hinge mechanism is then only required on the side of the hinge mechanism opposite of the side where the wiring is attached to said cover.

Moreover, due to an overall reduced movement of the wiring abrasion or the occurrence of scuffing marks is advantageously reduced or prevented.

In a further advantageous embodiment of the inventive household appliance said cover comprises at least one clamping means for detachably attaching said wiring to said cover.

Such clamping means advantageously allows for an easier mounting and secures an easier access to the wiring.

Moreover, the cover may be arranged such, that it may unhook by the inner plastic door in such a way as to facilitate handling of the wiring inside the hinge. The cover wiring can be unhook to facilitate access the wiring, for example, in case that there is a problem with the wiring. In addition, the wiring can be unhooked from the cover in the case that there is the need thereof.

In a further advantageous embodiment of the inventive household appliance, said second element comprises at least one guiding means for guiding of said wiring

Such guiding means preferably allows, within tolerances, only longitudinal movements of said wiring.

Such guiding means is of advantage in that a routing or guiding of the wiring is provided, particularly for a length compensation, which advantageously prevents the occurrence of unwanted abrasion or bending.

In a further advantageous embodiment of the inventive household appliance said at least one guiding means are arranged as an open channel.

This is of particular advantage in that a routing or guiding of the wiring is provided and the wiring is easy to be accessed.

In a further advantageous embodiment of the inventive household appliance said free end of said cover is arranged to slide over an opening of said at least one guiding means. This is of particular advantage in that during an opening cycle of one of said elements, e.g. a door, said hinge mechanism may have an opening angle of between about 0° and about 180°, whereas the cover wiring, and particularly the guiding means, may configured and positions such that in one side the wiring translates in the door and thus is moved and/or bend during such opening only about 120°, which advantageously avoids breakage and/or fatigue of the wiring.

In a further advantageous embodiment of the inventive household appliance, said second element comprises a cavity for the wiring.

According to the hinge mechanism, the cover, preferably, rotates around an axis of the hinge mechanism of the present invention on the side, while the other side moves inside a cavity on the inner plastic door. This particularly allows for a length compensation of the wiring, which secured that the wiring is not clamped or crimped in an unwanted manner.

This is of particular advantage, in that the excess cable length is stored in a secure and hidden manner.

In a further advantageous embodiment of the inventive household appliance said at least one guiding means are arranged at an opening of said cavity.

This advantageously allows for an optimal guidance of the wiring and, more particularly no section of the wiring is exposed to a pressure, particularly during an opening or closing of the closing element, which could lead to a bending and breakage of the wiring.

The above described problems are also advantageously solved by a hinge mechanism according to claim 13.

Such hinge mechanism is for a household appliance, for pivotal mounting of a first element to a second element, wherein a wiring is routed between said first element and said second element, and wherein the hinge mechanism comprises at least one pivot point, wherein said hinge mechanism is mechanically connecting said first element and said second element, such that said first element is arranged at a first side of said hinge mechanism and that said second element is arranged at a second side of said hinge mechanism,

wherein said household appliance further comprises a cover for said wiring,

characterized in that

said cover is pivotally attached at said first side of said hinge mechanism, wherein at least a section of said wiring is arranged between said hinge mechanism and said cover, and wherein, preferably the hinge mechanism is a hinge mechanism as described in connection with the various embodiments of a household appliance according to the present invention and/or the hinge mechanism according to the present invention.

The various embodiments of a hinge mechanism according to the present invention as described herein, are also embodiments of a household appliance according to the present invention comprising such hinge mechanism.

All described embodiments of the invention have the advantage, that an arrangement for guiding a wire according to the hinge mechanism or the household appliance according to the present invention, allows for connecting a first element to a second element with a wiring, wherein said wiring is accessible in an easier manner and arranged such that twisting and raveling, particularly during an open/closing movement is prevented. Moreover, such wiring is hidden from the user's view, and thus the hinge system acquires more esthetic value.

The present invention will be described in further detail with reference to the drawings from which further features, embodiments and advantages may be taken, and in which

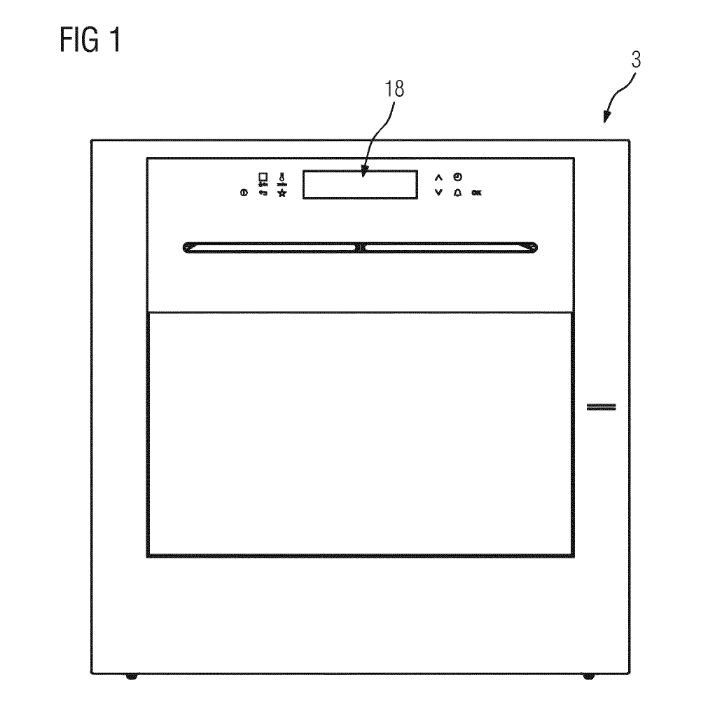

FIG. 1 illustrates a frontal view of a door of a household appliance according to a first inventive embodiment of the present invention comprising electrical elements;

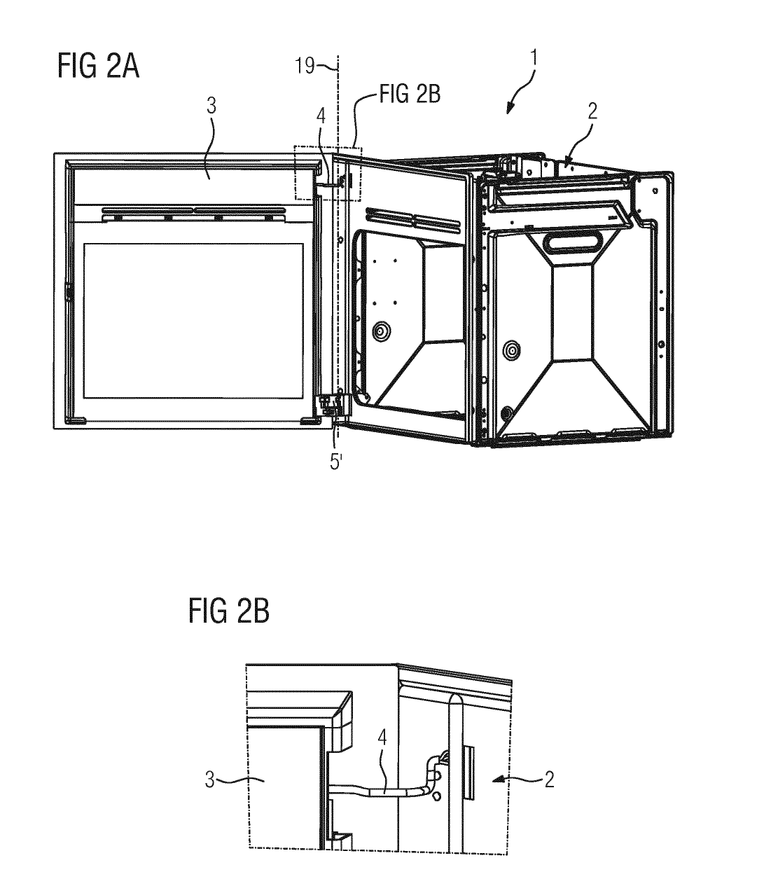

FIG. 2A illustrates a perspective view of an oven structure of a household appliance according to the first inventive embodiment of the present invention with an opened door attached to said oven structure;

FIG. 2B illustrates a detailed perspective view of an oven structure of a household appliance according to the first inventive embodiment of the present invention with an opened door attached to said oven structure;

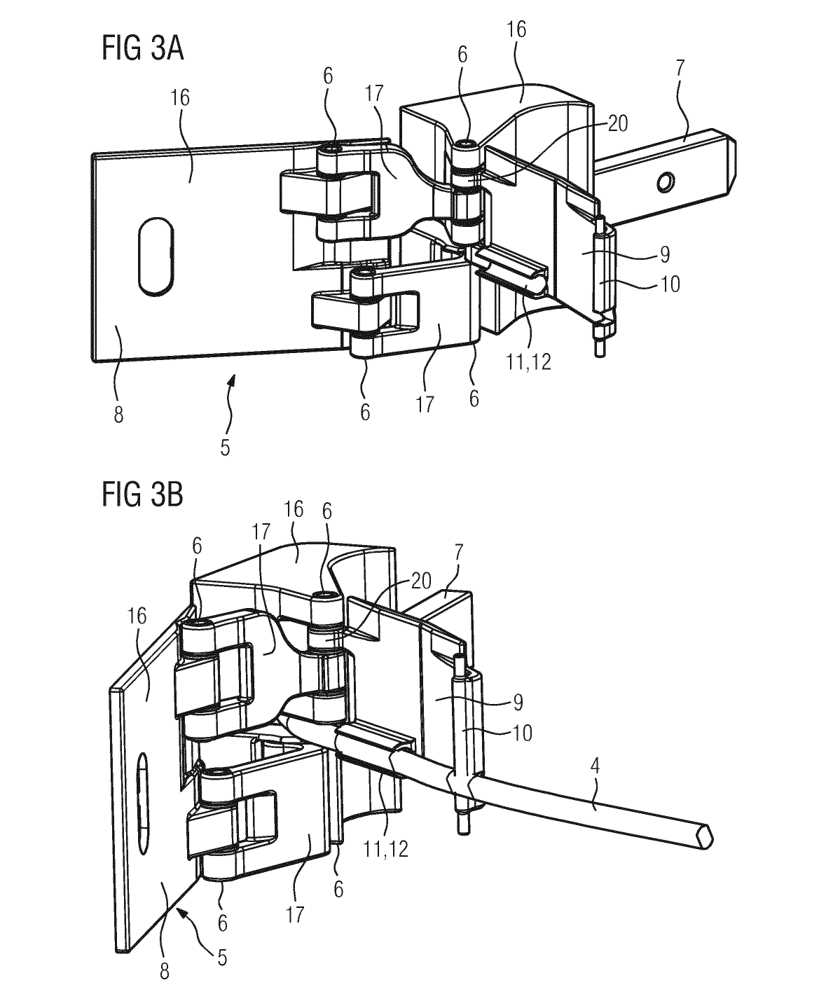

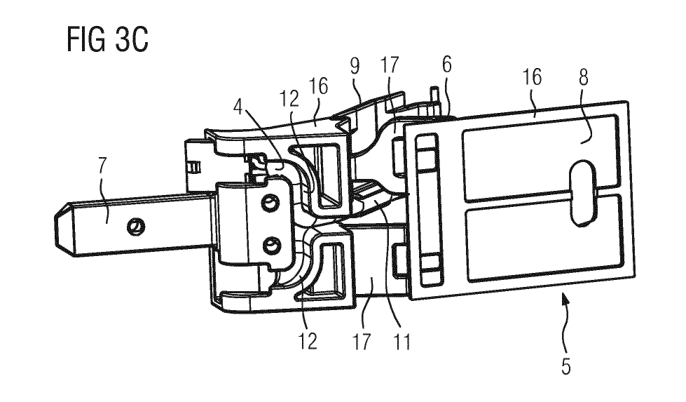

FIGS. 3A, 3B and 3C illustrate perspective views of a hinge mechanism according to the first inventive embodiment of the present invention;

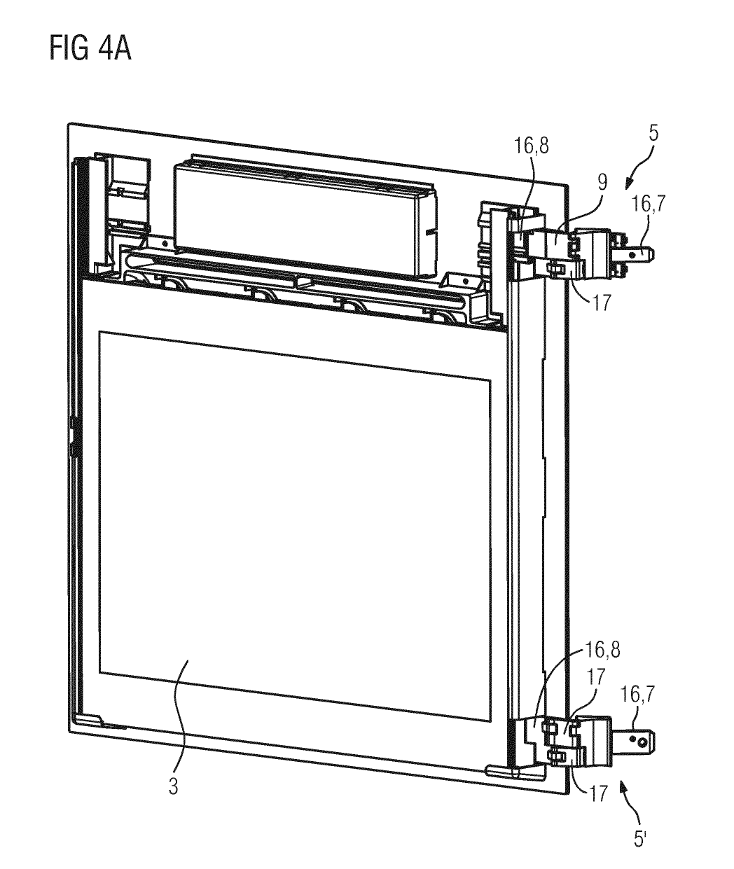

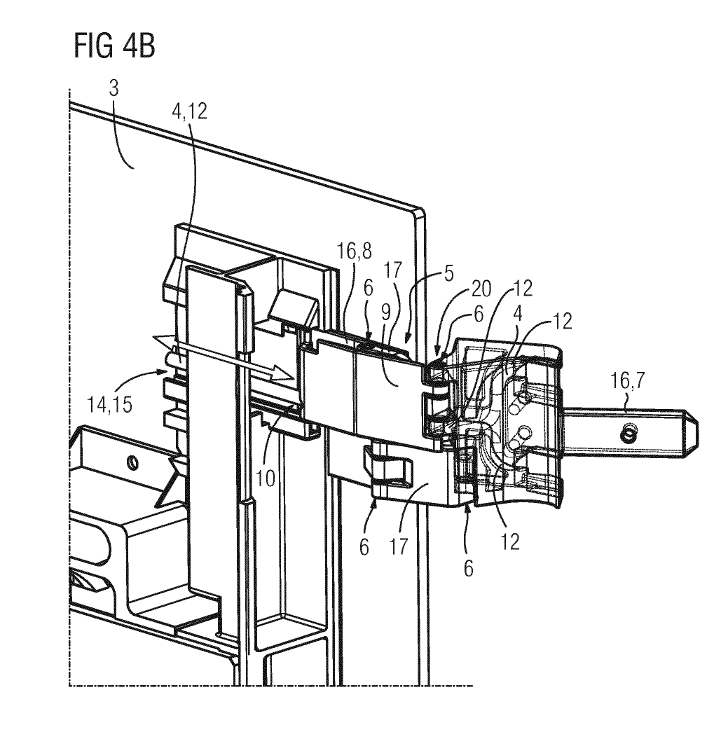

FIG. 4A illustrates a perspective view of a door with a mounted hinge mechanism of the household appliance according to the first inventive embodiment of the present invention;

FIG. 4B illustrates a detailed perspective view of a door with a mounted hinge mechanism of the household appliance according to the first inventive embodiment of the present invention;

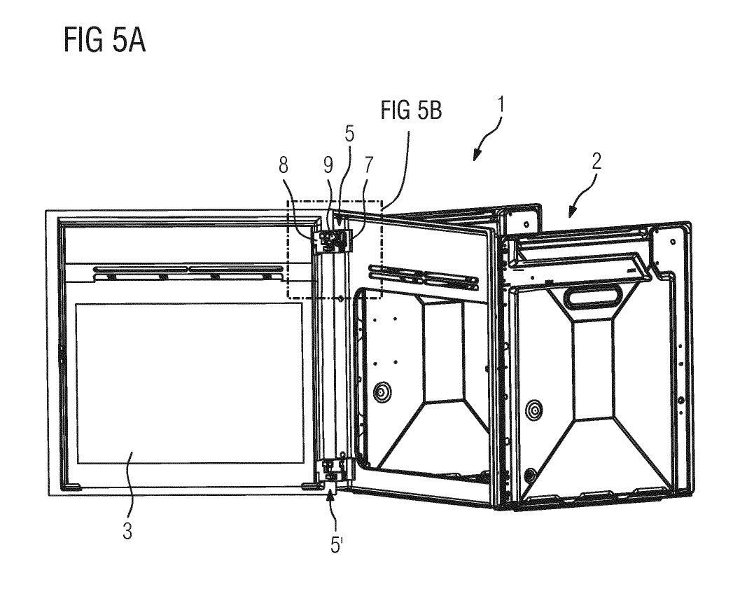

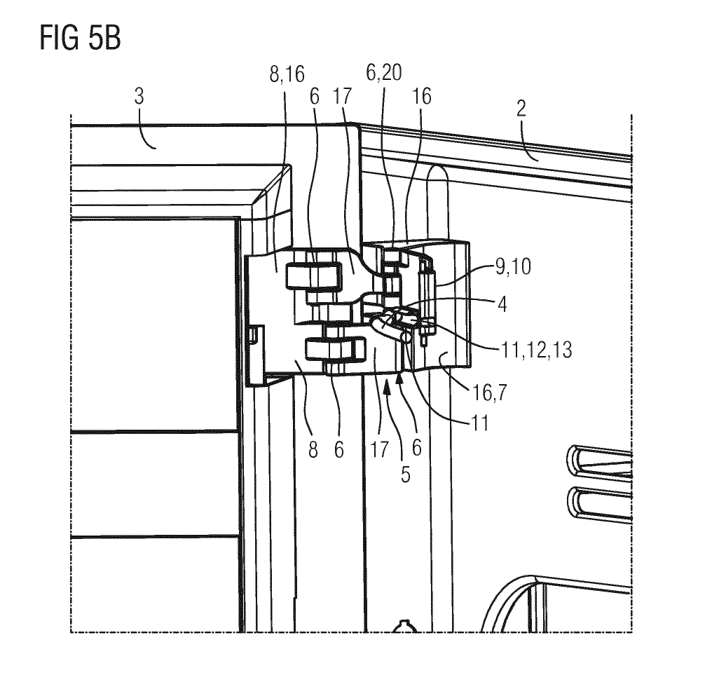

FIG. 5A illustrates a perspective view of an oven structure of the household appliance according to the first inventive embodiment of the present invention with an opened door attached to said oven structure;

FIG. 5B illustrates a detailed perspective view of an oven structure of the household appliance according to the first inventive embodiment of the present invention with an opened door attached to said oven structure;

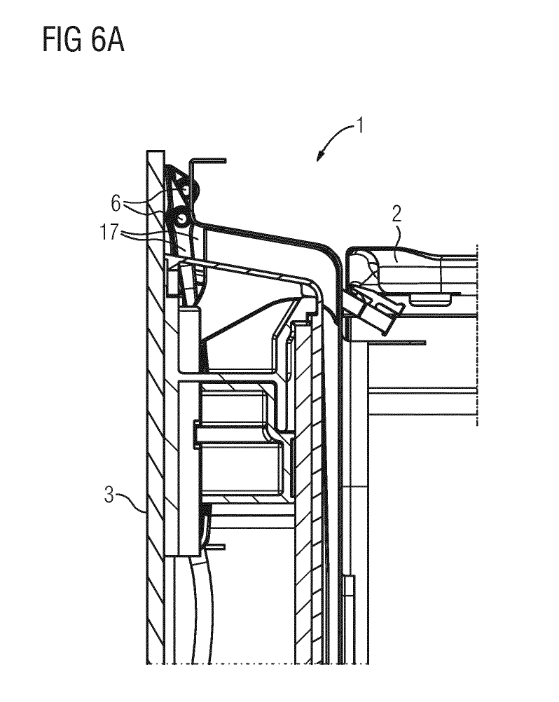

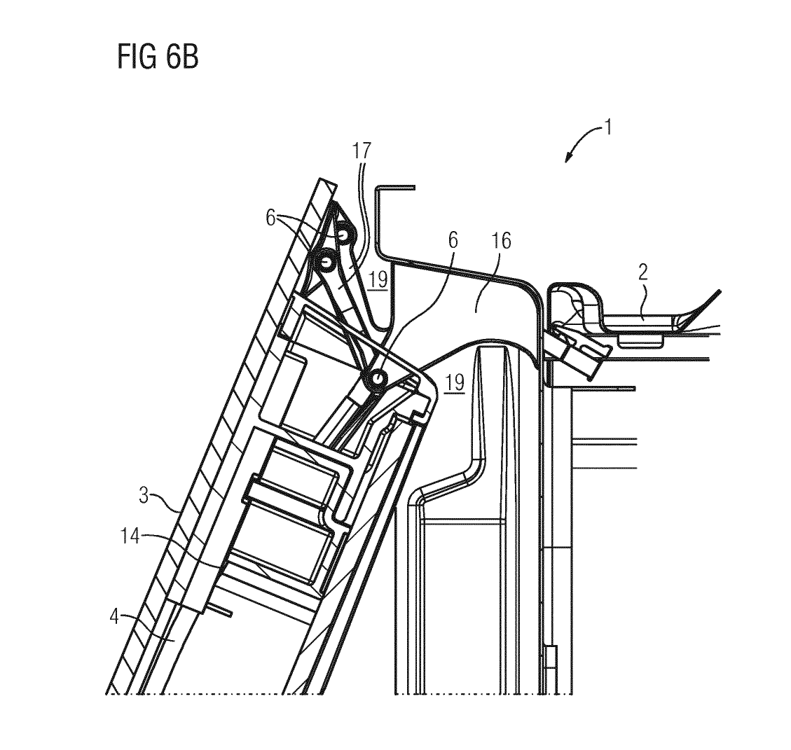

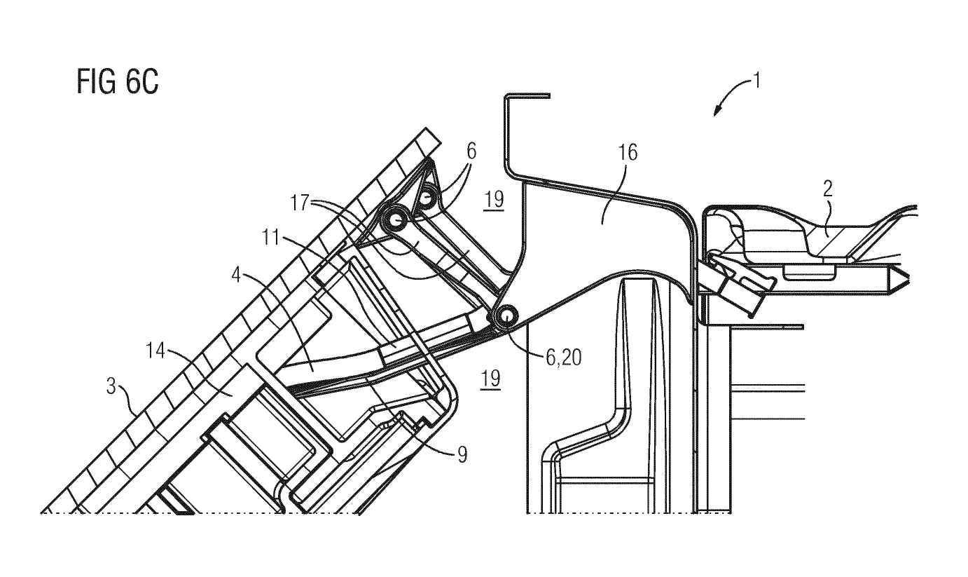

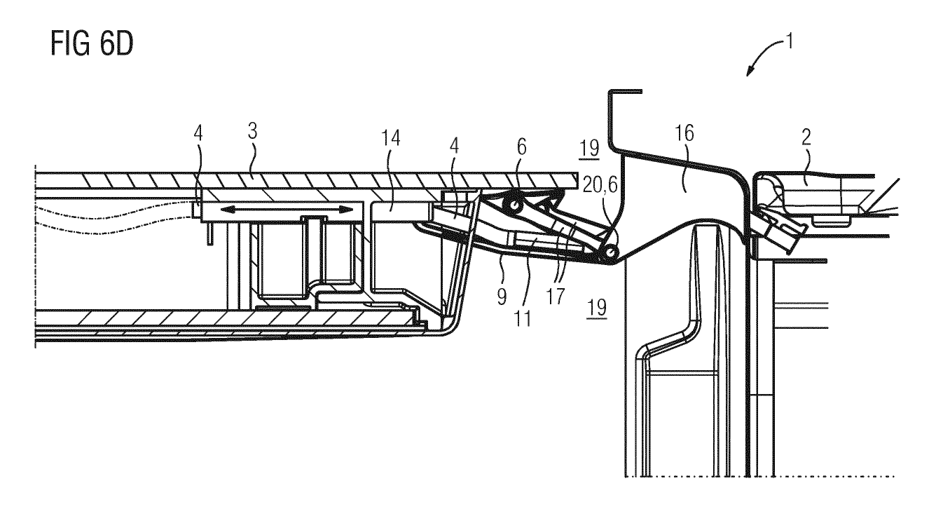

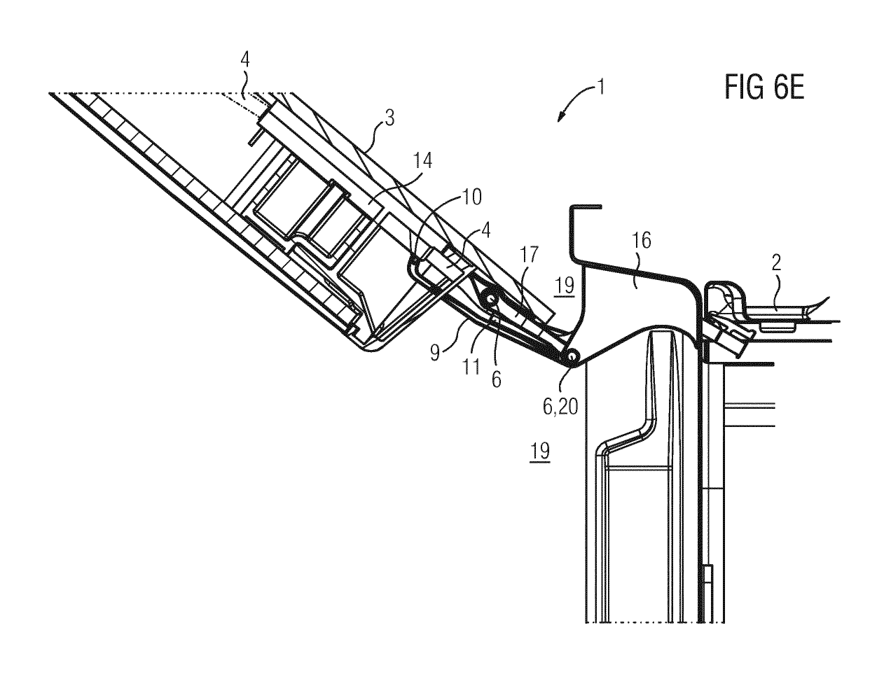

FIGS. 6A to 6E illustrate a series of a door of the household appliance according to the first inventive embodiment at different opening positions and, particularly a hinge mechanism according to the present invention.

FIG. 1 shows a front of a door 3 of a household appliance 1 according to a first inventive embodiment of the present invention. Said household appliance 1, here is an oven 1 comprising an oven cavity defined by two opposing side walls, a back wall and an upper and lower wall and a central frontal opening. The door 3 is to be mounted to the oven structure for opening and closing said frontal opening of said cavity.

The structure of the oven 1, here represents a first element 2 and the door 3 represents a second element 3. The door 3 comprises electronic elements 18, particularly a user interface, switches and a display, or the like, provided for an input by the user and the display of information of the cooking program and/or oven functions.

As may be best seen from FIG. 2A, and more particularly the detailed view FIG. 2B, a kitchen appliance 1 according to the present invention comprises a wiring 4 routed from said oven structure 2 to said door 3 and thereby. A wiring 4 routing from said oven structure 2 to said door 3, and traversing a gap 19 between the oven structure 2 and the door 3 connects the electronic elements 18 of said door 3 to a not shown power supply and/or control unit provided in said oven structure 2.

As may be best seen from FIG. 5A, and more particularly the detailed view 5B, the oven 1 comprises an upper hinge mechanism 5 and a lower hinge mechanism 5′, here both configured as a planar four-bar linkage.

The upper hinge mechanism 5 is shown in FIGS. 3A, 3B and 3C in more detail.

Such four-bar linkage 5 and 5′ is the simplest movable closed chain linkage. It consists of four bodies, called bars or links, connected in a loop by four joints or pivot points 6. It will be immediately understood that two opposing bars, referred to herein as the main bars 16 are each connected to either the first element or the second element. And two linkage bars each connect the two main bars 16. Generally, the joints are configured so the links move in parallel planes, and the assembly is called a planar four-bar linkage.

A four-bar-linkage is of advantage in that the door 3 and/or the hinge mechanism 5 and 5′, respectively, performs a translatory movement, which allows a particularly high opening angle, i.e. a wide opening. This is, as a four-bar-linkage 5, and 5′, respectively, is not restricted to a simple rotation about a single axis. By contrast, the door 3 hinged with such four-bar linkage 5 and 5′, respectively, can extend from the oven 1 during the opening movement.

It is the merit of the present inventors having found that the wiring 4 now has to follow this extend movement and therefore performs a translatory movement into the door 3. The upper hinge mechanism 5 comprises a cover 9, which here is not a carrying element of the door mechanism.

Here the four-bar linkage 5 and 5′ is mechanically connecting said oven structure 2 and said door 3, which may be best seen from FIG. 2A and FIG. 5A. Said connection is arrange such that said oven structure 2 is arranged at a first side 7 of said four-bar linkage 5 and 5′, respectively, and that said door 3 is arranged at a second side 8 of said four-bar linkage 5 and 5′ respectively.

Said oven 1, more particularly said upper hinge mechanism 5, further comprises a cover 9 for said wiring 4, wherein said cover 9 is pivotally attached at said first side 7 of said four-bar linkage 5, wherein at least a section of said wiring 4 is arranged between said four-bar linkage 5 and said cover 9.

It is to be understood that also a lower hinge mechanism 5′ may comprise such cover 9, particularly if a wiring 4 is traversing said vertical gap 19 at the lower part of the oven structure 2 and door 3.

It will be immediately understood that with the four-bar linkage 5 according to the present invention electronic elements 18, for example a user interface, switches and a display, or the like, integrated in or on such door 3, can be connected to the electronics of the other element, here the oven 1. This is particularly the case in that a wiring 4 is routed from said oven structure 2 to said door 3, as may be best seen from FIG. 1.

A four-bar linkage 5 and 5′ comprises at least one pivot point 6, preferably four pivot points 6, and is mechanically connecting said oven structure 2 and said door 3. Thereby, the hinge mechanism 5 and 5′ allows for a pivotal movement, e.g. an opening movement, of one of the door 3 relative to the oven structure 2.

The four-bar linkage 5 according to the present invention comprises a cover 9 for said wiring 4, more particularly for covering said wiring 4. This is of particular advantage, in that said cover 9 protects the wiring 4 against damage, however, may also be of esthetic purpose, in that the wiring 4 is advantageously hidden from the view of the user.

In that said cover 9 is pivotally attached at said first side 7 of said hinge mechanism the cover 9 may be opened or closed, or tilted. In FIGS. 3A and 3B, the cover 9 is shown in an open stage, wherein FIGS. 4A and 4B shows the cover 9 in a closed stage. This is of particular advantage in that the cover is movable and the wiring 4 is accessible easily. Accordingly, mounting of such wiring 4 is also advantageously facilitated.

Said cover 9 is pivotally attached at said first side 7 of said hinge mechanism 5, wherein at least a section of said wiring 4 is arranged between said hinge mechanism 5 and said cover 9. Said section here refers to the section, which is the section of the wiring 4 routing from said oven structure 2 to said door 3, and traversing a gap 19 between the oven structure 2 and the door 3. It will, however be understood, that such wiring 4 will further route into or along the oven structure 2 and the door, in order to be connected to its target, e.g. the electric elements 18 of the door and a power circuit of the oven 1.

In particular, from FIG. 4B it is immediately understood that the wiring 4 is arranged such that a translational movement of said wiring 4 in its longitudinal direction is allowed in a cavity-like structure provided on the inner side of the door 3, depicted by the double headed arrow.

FIGS. 6A to 6E illustrate a series of sectional detailed views of a door hinged to the household appliance according to the first inventive embodiment with a four-bar linkage 5 shown at different opening positions and, particularly a hinge mechanism according to the present invention. More particularly, FIG. 6A illustrates a section of the hinge 5 and the door 3 at an opening angle of about 0°; FIG. 6B illustrates a section of the hinge 5 and the door 3 at an opening angle of about 22.5°, FIG. 6C illustrates a section of the hinge 5 and the door 3 at an opening angle of about 45°; FIG. 6D illustrates a section of the hinge 5 and the door 3 at an opening angle of about 90°; and FIG. 6E illustrates a section of the hinge 5 and the door 3 at an opening angle of about 130°.

Thereby, it is to be understood that the wiring 4 here, routes from said oven structure 2 to said door 3 at the level or height of the four-bar linkage 5. The section which is the section of the wiring 4 routing from said oven structure 2 to said door 3 is arranged within the four-bar linkage 5 of the oven 1. The cover 9 here, is part of the four-bar linkage 5. It may be also taken from the provided Figs that the wiring 4 is guided inside the hinge itself, and, particularly the wiring 4 is not guided in a level above, below or next to the hinge, which may be seen in particular from FIG. 4B.

As may be taken immediately from FIGS. 3A and 3B the cover 9 is pivotally attached at said first side 7 of said four-bar linkage 5. Said cover 9 extends from said oven structure 2 to said door 3, wherein the free end 10 of said cover 9 is or can be brought into contact with said door 3, more particularly with the second side 8. AS may be best seen from FIGS. 3A and 3B, the free end 10 of said cover 9 refers to the side of said cover 9, opposite to its pivotal attachment 20, where the cover 9 is pivotally attached about an axis. In a closed stage of the cover 9 as, for example, shown in FIG. 4B, the gap 19 between the oven structure 2 and the door 3 is advantageously covered, which may be taken, for example from FIG. 2A. Here, the wiring 4 is attached to said cover 9 and the cover 9 comprises a clamping means 11 for detachably attaching said wiring 4 to said cover 9. Such clamping means 11 advantageously allows for an easier mounting and secures an easier access to the wiring 4. The inner door 3 comprises at least one guiding means 12 for guiding of said wiring 4. Such guiding means preferably allows, within tolerances, only longitudinal movements of said wiring 4. This allows for an advantageous translational movement of the wiring 4 within its longitudinal extension and direction. Thus, the wiring 4 is held flexible with regard to the tension applied by the opening and/or closing movement of the door 3. Accordingly, the wiring 4 will upon such opening and/or closing movement of the door 3 not demolish or tear off. By contrast, a force applied on the wiring 4 pulling or pushing said wiring in its longitudinal direction will be compensated by the free movement of the wiring 4 in its longitudinal direction.

Here said guiding means 12 are arranged as an open channel and the free end 10 of said cover 9 is arranged to slide over said opening 13 of said at least one guiding means 12. The door 3 further comprises a cavity 14 for the wiring 4 and the guiding means 12 are arranged at an opening 15 of said cavity 14.

The various embodiments of a four-bar linkage 5 according to the present invention as described herein, are also embodiments of an oven according to the present invention comprising such hinge mechanism 5.

The cover 9 during the complete opening of the door 2 does not carry out the same movement of the links 17, but by a side rotates around an axis of the four bar mechanism 5 while the other side moves inside the cavity on the inner door 2, plastic door, by doing so the wiring bends at max 120° during the opening, while if the cover were to follow the: movement of the one link of the cable would bend of the 180° condition of possible breakage.

The features of the present invention disclosed in the specification, the claims, and/or the figures may both separately and in any combination thereof be material for realizing the invention in various forms thereof.

### LIST OF REFERENCE NUMERALS

1 Household appliance, oven
2 first element, oven structure
3 second element, oven door
4 wiring
5, 5′ hinge mechanism
6 pivot point
7 first side
8 second side
9 cover
10 free end of wire cover
11 clamping means
12 guiding means
13 opening of said guiding means
14 cavity for wiring
15 opening of said cavity
16 main bars
17 linkage bars
18 electronic elements
19 gap
20 pivotal attachment of cover

1. A household appliance comprising a first element and a second element with wiring routed from said first element to said second element, and a hinge mechanism comprising at least one pivot point, wherein said hinge mechanism is mechanically connecting said first element and said second element, such that said first element is arranged at a first side of said hinge mechanism and that said second element is arranged at a second side of said hinge mechanism, wherein said household appliance further comprises a cover for said wiring, wherein said cover is pivotally attached at said first side of said hinge mechanism, wherein at least a section of said wiring is arranged between said hinge mechanism and said cover.

2. The household appliance according to claim 1, wherein one of said elements is a structure of the household appliance and the other of said elements is a door.

3. The household appliance according to claim 1, wherein said hinge mechanism is configured as a four-bar-linkage.

4. The household appliance according to claim 1, wherein said cover is pivotally attached at said pivot point (6) of said hinge mechanism.

5. The household appliance according to claim 1, wherein said cover extends from said first element to said second element, wherein a free end of said cover is or can be brought into contact with said second element.

6. The household appliance according to claim 1, wherein said wiring is attached to said cover.

7. The household appliance according to claim 6, wherein said cover comprises at least one clamping means for detachably attaching said wiring to said cover.

8. The household appliance according to claim 1, wherein said second element comprises at least one guiding means for guiding of said wiring.

9. The household appliance according to claim 8, wherein said at least one guiding means is arranged as an open channel.

10. The household appliance according to claim 5, said second element comprising at least one guiding means for guiding said wiring, wherein said free end of said cover is arranged to slide over an opening of said at least one guiding means.

11. The household appliance according to claim 1, wherein said second element comprises a cavity for the wiring.

12. The household appliance according to claim 11, said second element comprising at least one guiding means for guiding said wiring and a cavity for the wiring, wherein said at least one guiding means is arranged at an opening of said cavity.

13. Hinge mechanism for a household appliance, for pivotal mounting of a first element to a second element, wherein a wiring is routed between said first element and said second element, and wherein the hinge mechanism comprises at least one pivot point, wherein said hinge mechanism is mechanically connecting said first element and said second element, such that said first element is arranged at a first side of said hinge mechanism and that said second element is arranged at a second side of said hinge mechanism, wherein said household appliance further comprises a cover for said wiring, characterized in that said cover is pivotally attached at said first side of said hinge mechanism, wherein at least a section of said wiring is arranged between said hinge mechanism and said cover, and wherein, the hinge mechanism is a hinge mechanism according to claim 1.
